(19) United States
(12) Patent Application Publication
(10) Pub. No.: US 2026/0194783 A1
(43) Pub. Date: Jul. 9, 2026

(54) METHOD OF CLEARING AN ELECTROCHROMIC DEVICE

(71) Applicant: Gentex Corporation, Zeeland, MI (US)

(72) Inventors: Ryan Barrido Balili, Holland, MI (US); Justin D. Jansen, Hudsonville, MI (US)

(21) Appl. No.: 19/412,936

(22) Filed: Dec. 9, 2025

Related U.S. Application Data
(60) Provisional application No. 63/742,005, filed on Jan. 6, 2025.

(51) Int. Cl. G02F 1/163

(52) U.S. Cl. CPC G02F 1/163

(57) ABSTRACT

According to one aspect of the present disclosure, a method is provided for clearing an electrochromic device including the steps of applying a reverse bias to the electrochromic device for a first predetermined time, and shorting the electrochromic device until cleared. The method further includes, after applying the reverse bias, (1) applying to the electrochromic device for a second predetermined time at least one of: a forward bias at constant voltage and a float, and/or (2) applying the reverse bias at decreasing voltages.

### CROSS-REFERENCE TO RELATED APPLICATION

This application claims priority under 35 U.S.C. § 119(e) upon U.S. Provisional Ser. No. 63/742,005 , entitled “METHOD OF CLEARING AN ELECTROCHROMIC DEVICE” filed on Jan. 6, 2025, by Ryan Barrido Balili et al., the entire disclosure of which is incorporated herein by reference.

### TECHNICAL FIELD

The present disclosure generally relates to a method of clearing an electrochromic device and more particularly to an improved method of clearing an electrochromic large area device (LAD) such as a vehicle window or sunroof or an architectural window.

### SUMMARY

According to one aspect of the present disclosure, a method is provided for clearing an electrochromic device that has previously been darkened by application of a forward bias voltage, the method including the steps of: applying a reverse bias to the electrochromic device for a first predetermined time; applying to the electrochromic device for a second predetermined time at least one of: a forward bias voltage and a float; and shorting the electrochromic device until cleared.

According to another aspect of the present disclosure, a method is provided for clearing an electrochromic device that has previously been darkened by application of a forward bias voltage, the method including the steps of: applying a reverse bias at decreasing voltage to the electrochromic device for a first predetermined time; and shorting the electrochromic device until cleared.

According to another aspect of the present disclosure, a method is provided for clearing an electrochromic device that has previously been darkened by application of a forward bias voltage, the method including the steps of: applying a reverse bias to the electrochromic device for a first predetermined time; applying a forward bias to the electrochromic device for a second predetermined time; and shorting the electrochromic device until cleared.

These and other features, advantages, and objects of the present disclosure will be further understood and appreciated by those skilled in the art by reference to the following specification, claims, and appended drawings.

### BRIEF DESCRIPTION OF THE DRAWINGS

The present disclosure will become more fully understood from the detailed description and the accompanying drawings, wherein:

FIG. 1A is a perspective view of an automobile that incorporates at least one electro-optic element, in accordance with an aspect of the present disclosure;

FIG. 1B is a perspective view of an airplane that incorporates at least one electro-optic element, in accordance with an aspect of the present disclosure;

FIG. 1C is a perspective view of a building that incorporates at least one electrochromic large area device (LAD), in accordance with an aspect of the present disclosure;

FIG. 2 is a front perspective view of an electrochromic LAD

FIG. 3 is a cross-sectional view of the electrochromic LAD 10 taken along line III-III;

FIG. 4 is an enlarged partial cross-sectional view of the interior cell of the electrochromic LAD with a forward bias voltage applied across the electrodes;

FIG. 5 is an enlarged partial cross-sectional view of the interior cell of the electrochromic LAD with a float applied across the electrodes;

FIG. 6 is an enlarged partial cross-sectional view of the interior cell of the electrochromic LAD with a short applied across the electrodes;

FIG. 7 is an enlarged partial cross-sectional view of the interior cell of the electrochromic LAD with a reverse bias voltage applied across the electrodes;

FIG. 8 is a graph comparing the edge to center darkening and clearing using a reverse bias voltage followed by a short;

FIG. 9 is a flowchart illustrating a first method of clearing an electrochromic LAD;

FIG. 10 is a graph comparing the edge to center darkening and clearing using the first method shown in FIG. 9;

FIG. 11 is a flowchart illustrating a second method of clearing an electrochromic LAD;

FIG. 12 is a graph comparing the edge to center darkening and clearing using the second method shown in FIG. 11;

FIG. 13 is a flowchart illustrating a third method of clearing an electrochromic LAD;

FIG. 14 is a graph comparing the edge to center darkening and clearing using the third method shown in FIG. 13;

FIG. 15 is a graph comparing the edge to center darkening and clearing using the third method shown in FIG. 13;

FIG. 16 is flowchart illustrating a fourth method of clearing an electrochromic LAD; and

FIG. 17 is a graph comparing the edge to center darkening and clearing using the fourth method shown in FIG. 16.

### DETAILED DESCRIPTION

The present illustrated embodiments reside primarily in combinations of method steps and apparatus components related to an electro-optic subassembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

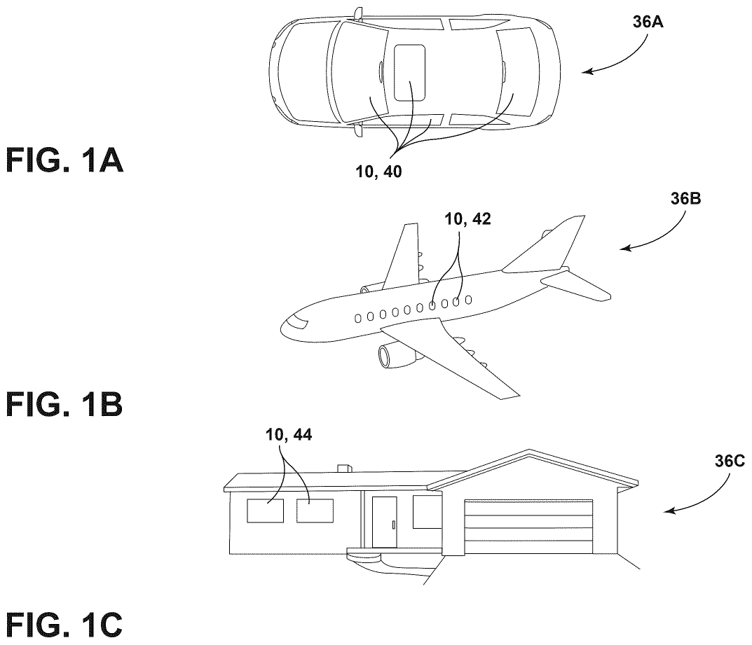

As discussed further below, the present disclosure pertains to an electrochromic large area device (LAD) such as windows and sunroofs for land vehicles, windows for airplanes, or architectural windows for buildings. More specifically, the present disclosure pertains to a method for clearing electrochromic LADs. LADs have incorporated electrochromic devices that may be selectively darkened to enhance privacy and to reduce the brightness of light passing therethrough. With reference now to FIGS. 1A-1C, an electrochromic LAD 10 may be incorporated with one or more structures 36A-36C. For example, FIG. 1A illustrates a vehicle 36A employing the electrochromic device 10. All or some components of the electrochromic device 10 may be located within, or at least partially form, a vehicle window or sunroof 40. The vehicle 36A may include a commercial vehicle, an emergency vehicle, a residential vehicle, a train, or the like. FIG. 1B illustrates an airplane 36B employing the electrochromic device 10. The electrochromic device 10 may be located within, or at least partially form, an airplane window 42. FIG. 1C illustrates a building 36C employing the electrochromic device 10. The electrochromic device 10 may be located within, or at least partially form, a building window 44. Generally speaking, the electrochromic device 10 may be incorporated into any LAD in any environment wherein changing transmittance and/or reflectivity is beneficial.

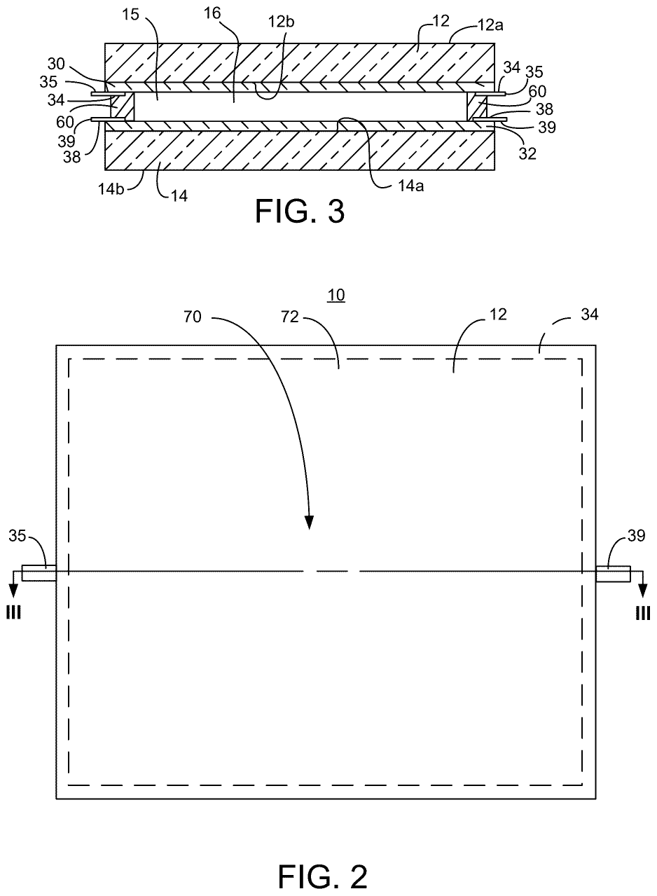

An example of an electrochromic LAD 10 is shown in FIGS. 2 and 3. FIG. 2 is a front view of the LAD 10 and FIG. 3 is a cross-sectional view of the electrochromic LAD 10 taken along line III-III. The electrochromic LAD 10 includes two transparent substrates 12 and 14 that are spaced apart and generally in parallel with one another. The first substrate 12 includes a first surface 12a and a second surface 12b, which is opposite the first surface 12a. Similarly, the second substrate 14 includes a first surface 14a and a second surface 14b, which is opposite the first surface 14a. A first transparent electrode 30 is provided on the second surface 12b of the first substrate 12. A second transparent electrode 32 is provided on the first surface 14a of the second substrate 14. A seal 60 is provided between the substrates 12 and 14 about the perimeter of the device so as to provide a sealed chamber 15 in which an electrochromic medium 16 is provided.

A first electrical bus 34 is provided about the outer perimeter of the first electrode 30 in electrical contact therewith. Similarly, a second electrical bus 38 is provided about the outer perimeter of the second electrode 32 in electrical contact therewith. The first bus 34 has at least one contact tab 35 and the second bus 38 has at least one contact tab 39. Both of the contact tabs 35 and 39 are provided to allow electrical connection to a power source for application of a controlled voltage or current to the electrodes to thereby control the coloration/clearing of the electrochromic medium 16. The number and arrangement of tabs 35 and 39 may vary from what is shown in the drawings. Specifically, the tabs 35 and 39 may be staggered about the periphery of LAD 10.

The electrical buses 34 and 38 are made of a highly conductive material that is more conductive than the material used to form the transparent electrodes 30 and 32 in order to more uniformly apply the applied voltage/current around the perimeter of the electrodes 30 and 32.

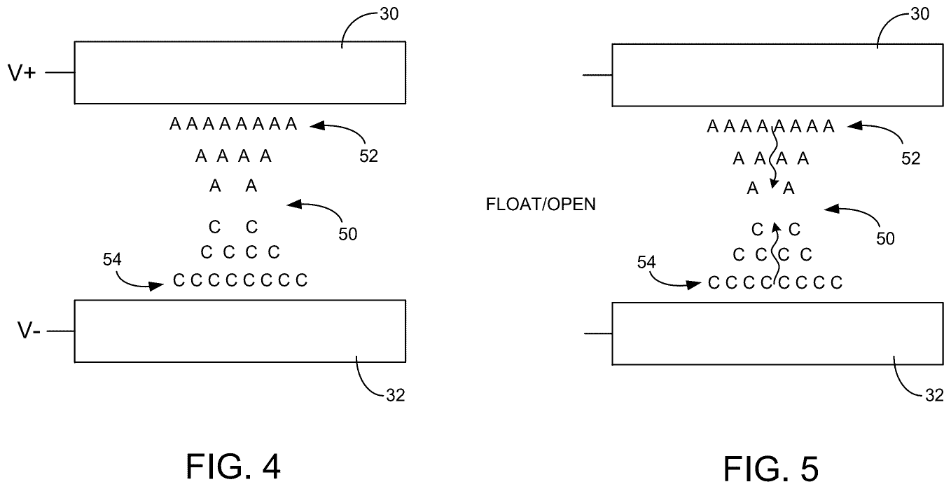

On problem encountered with such electrochromic LADs relates to the inability to uniformly apply the applied voltage across the entire area of the LAD 10. This may cause the LAD 10 to not color or clear uniformly across its entire surface area. In particular, the center 70 of the LAD 10 may be slower to color and to clear than the perimeter 72. This leads to an undesirable visible “halo” effect. To better explain this “halo” effect, the different applications or nonapplications of voltage and their effects on the species of the electrochromic medium 16 are first described below with reference to FIGS. 4-7.

FIG. 4 is an enlarged partial cross-sectional view of the interior cell of the electrochromic LAD 10 with a forward bias voltage applied across the electrodes 30 and 32. A forward voltage is typically applied in order to initially cause the electrochromic medium to become colored or darkened, which decreases the transmission of light through the LAD 10. The electrochromic medium 16 includes at least one anodic species (designated as “A”) and at least one cathodic species (designated as “C”). Initially, with no voltage applied, the anodic and cathodic species appear clear or fully transparent, they are in neutral states, with no gain or loss of electrons. When a forward bias voltage is applied as shown in FIG. 4, a positive voltage is applied to the first electrode 30 and a negative voltage is applied to second electrode 32. This forward bias causes the anodic species to lose electrons and the cathodic species to gain electrons, an oxidation/reduction reaction respectively. When this occurs the anodic and cathodic species visibly change color. Given the large area of the device, the impact of the forward bias voltage is not uniform across the width or length of the device. In fact, the effective voltage drops from the edge of the device to the center of the device. The rate at which the anodic and cathodic species are charged or colored is proportional to voltage. Hence, the edge generates color faster than the center. In addition, after steady state or equilibrium has been reached, the concentration of the CHARGED or COLORED anodic and cathodic electrochromic species are higher near the electrodes (regions 52 and 54). That is because, as the charged/colored electrochromic species diffuse toward the middle 50 of the cell, the complementary charged chromophores/electrochromic species meet and return to their neutral/uncharged/colorless state.

In general, there are three different ways of clearing the LAD 10. First, one can merely stop applying the forward bias voltage thereby allowing a float, which is like an open circuit. Second, one can short the LAD 10. Last, one can apply a reverse bias voltage.

FIG. 5 is an enlarged partial cross-sectional view of the interior cell of the electrochromic LAD 10 with a float applied across the electrodes 30 and 32. the anodic and cathodic species diffuse through the electrochromic medium 16 towards the middle region 50 where they exchange electrons and become neutrally charged and therefore become clear. However, with the anodic species in the region 52 and the cathodic species in the region 54 being separated and concentrated in those regions, the clearing rate is limited to the diffusion rate of the species within the medium 16.

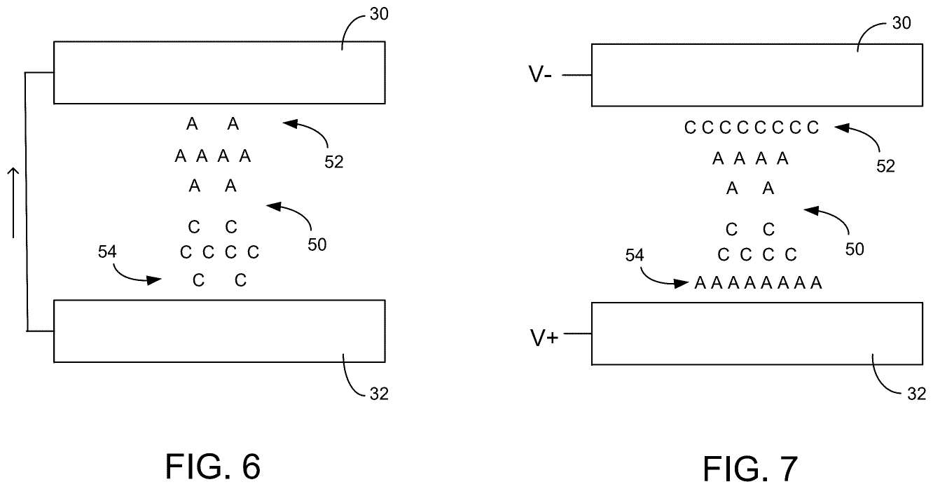

FIG. 6 is an enlarged partial cross-sectional view of the interior cell of the electrochromic LAD with a short applied across the electrodes. In this case, the extra electrons held by the cathodic species flow directly between the electrodes 30 and 32 to thereby neutralize the charge on the anodic and cathodic species in regions 52 and 54 closest to those electrodes. The anodic and cathodic species in the middle regions may still exchange electrons. However, the species in between the middle region 50 and outer regions 52 and 54 will be the slowest to exchange electrons and thereby clear. Nevertheless, shorting the electrodes 30 and 34 clears the LAD 10 faster than floating the electrodes.

FIG. 7 is an enlarged partial cross-sectional view of the interior cell of the electrochromic LAD with a reverse bias voltage applied across the electrodes 30 and 32. Here, a positive voltage is applied to the second electrode 32 while a negative voltage is applied to the first electrode 30. This causes the creation of “counter species” in the regions 52 and 54. These counter species are, for example, reduced cathodic species in region 52 and oxidized anodic species in region 54. These counter species quickly exchange electrons with the opposite species that are present in those regions in high concentrations. Further still, these counter species are proximate the species in the area between the middle region 50 and the outer regions 52 and 54 so as to more quickly neutralize the species in that area.

In comparing the above methods, the float is the slowest method for clearing although it provides the most uniform clearing across the entire surface of the LAD 10. This is because there is no reliance upon a voltage or short applied across the electrodes 30 and 32. All that is left is to diffuse and that is random. Since the colored/charged species are created across each other, at the opposite electrodes, the likely (note random), meeting place is somewhere in the middle of the cell, where the species meet their counterpart to return or gain what charge they have gained or lost. In the other methods, when a voltage or short is applied across the electrodes 30 and 32 it is applied via the busses 34 and 38 which are in the perimeter region 72 of LAD 10 (FIG. 2) and thus the voltage between the electrodes 30 and 32 is greater in the perimeter region 72 than it is in the center region 70. Thus, the impact of such a voltage or short is greater in the perimeter region 72 than it is in the center region 70. Accordingly, the short or reverse bias methods can lead to the undesirable visible “halo” effect described above whereby the device is clearer around the perimeter and darker in the center. Nevertheless, the short and reverse bias methods are faster, and it is generally desirable to clear the device quickly.

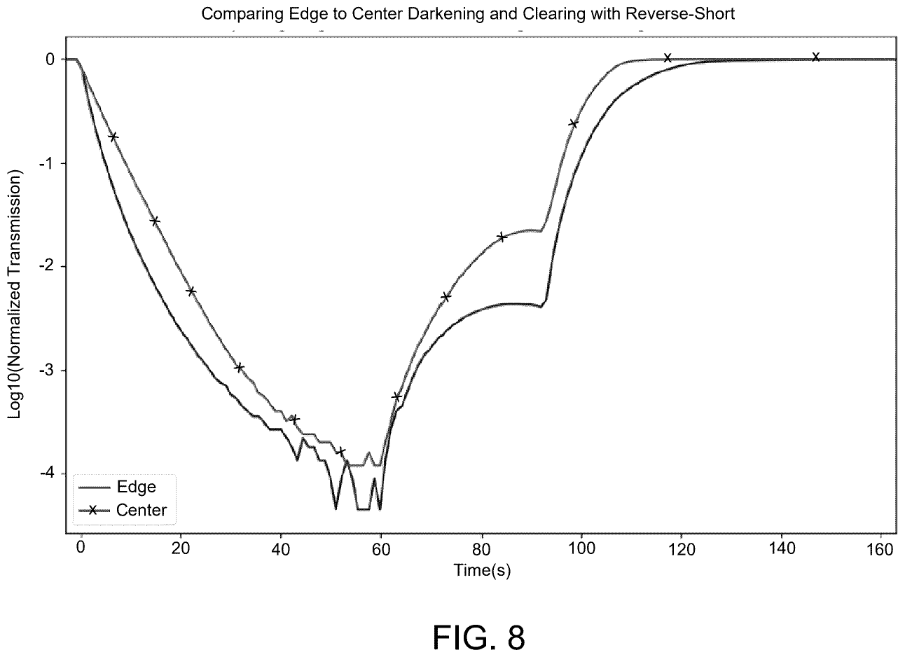

Currently, LADs are cleared by first applying a reverse bias voltage and then applying a short. This is considered the quickest method to clear an LAD. However, it causes the above mentioned visible “halo” effect. FIG. 8 shows a graph comparing the edge to center darkening and clearing using a reverse bias voltage followed by a short. More specifically, a forward bias at 1.2V for 60 seconds was applied to darken the LAD. One graph line shows the transmission over time for the perimeter (edge) region 72 and the other graph line shows the transmission over time for the center region 70. The greater the divergence of these lines at any point in time, the greater the visibility of the difference in transmission in these regions 70 and 72. After 60 seconds of darkening, a reverse bias at constant voltage is applied for 33 seconds and then a short is applied until the LAD is cleared. As apparent from the graph, near the end of the 33 seconds of reverse bias, the LAD actually begins to darken again in the perimeter region 72 and stops clearing in the center region 70. This is when the halo effect is most visible. This darkening is caused by an excess production of counter electrodes, which themselves have color. It is not just the “halo” effect that is being mitigated. Notice that from time=70 secs to time =90 secs, the transmission curve seems to flatten. When this happens during reverse bias, the viewer's impression is that nothing happens, e.g. they may think that the clearing process has stalled or was aborted. The methods presented below make it look like the electrochromic device clears continuously like it darkens continuously,

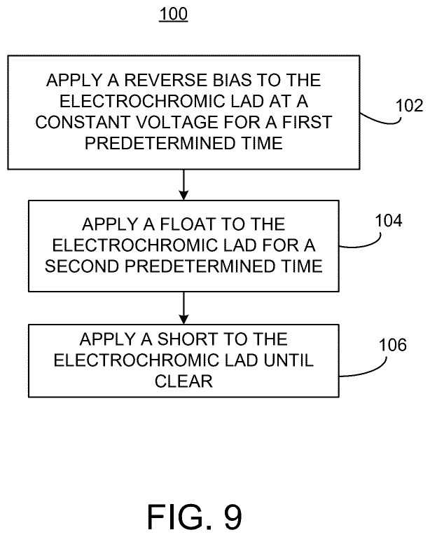

Accordingly, it is desirable to improve the method of clearing so as to minimize the appearance of any halos. The following methods described with respect to FIGS. 9-18 address this problem with the prior method.

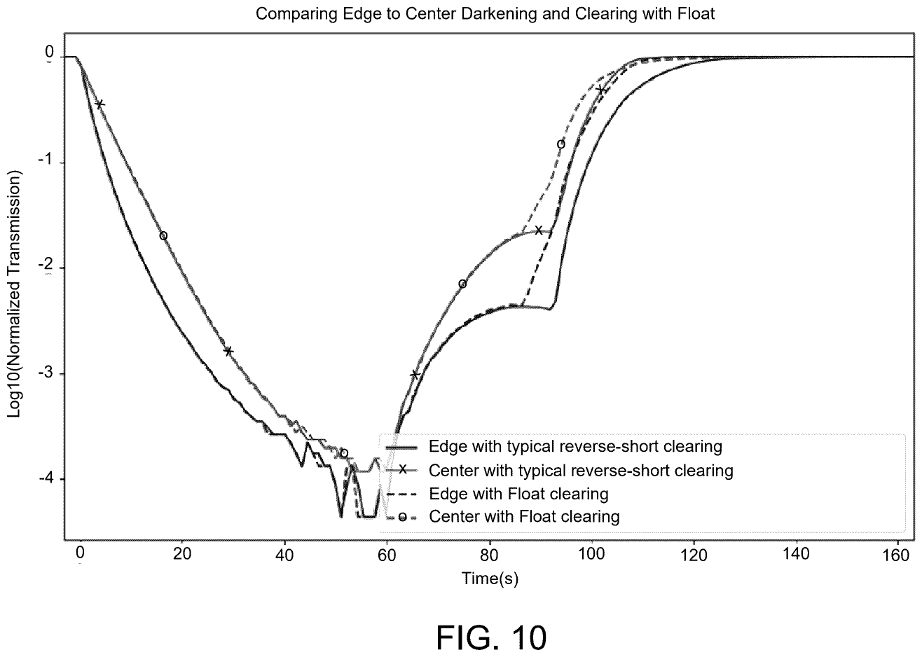

A first method 100 to improve clearing is illustrated in FIG. 9. In this first method 100, a reverse bias at a constant voltage is first applied for a first predetermined time (step 102), followed by a float step for a second predetermined period of time (step 104) and then a short until clear (step 106). FIG. 10 shows a graph comparing the impact of this first method 100 on transmission at the perimeter and center regions. In the example used to create the graph, the negative bias is applied for 27 seconds, and the float is applied for 6 seconds. As compared to the prior method, the transmission curve shows some flattening especially at the perimeter region 72, however it is less than the other method and it does not begin to darken.

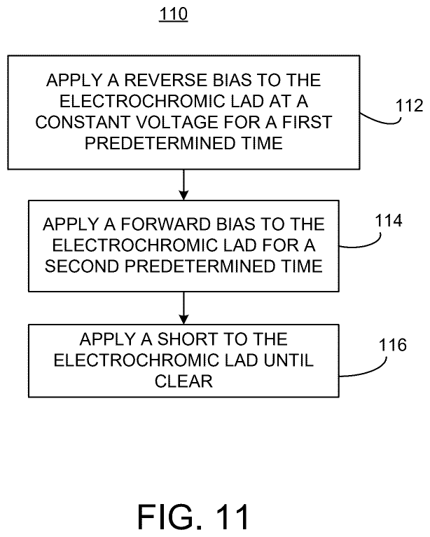

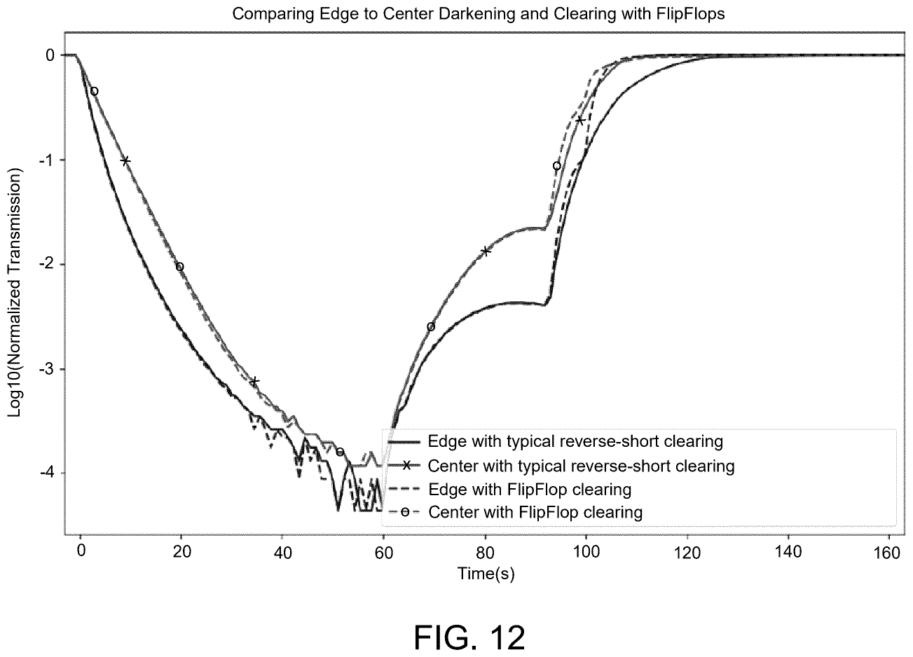

A second method 110 to improve clearing is illustrated in FIG. 11. In this second method 110, a reverse bias at a constant voltage is first applied for a first predetermined time (step 112), followed by application of forward bias voltage for a second predetermined period of time (step 114) and then a short until clear (step 116). By applying the forward bias after the reverse bias (also referred to herein as a “flip flop”), any excess counter species are removed by generating a small amount of additional species. FIG. 12 shows a graph comparing the impact of this second method 110 on transmission at the perimeter and center regions. In the example used to create the graph, the negative bias is applied for 33 seconds, and the positive bias is applied for 7 seconds. As compared to the prior method, the transmission curve shows that the perimeter region 72 clearing was able to keep up with the center clearing giving a more uniform clearing on the LAD 10.

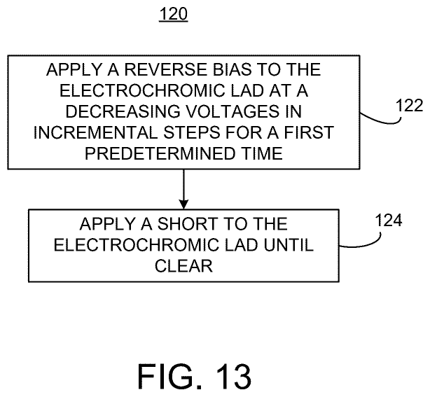

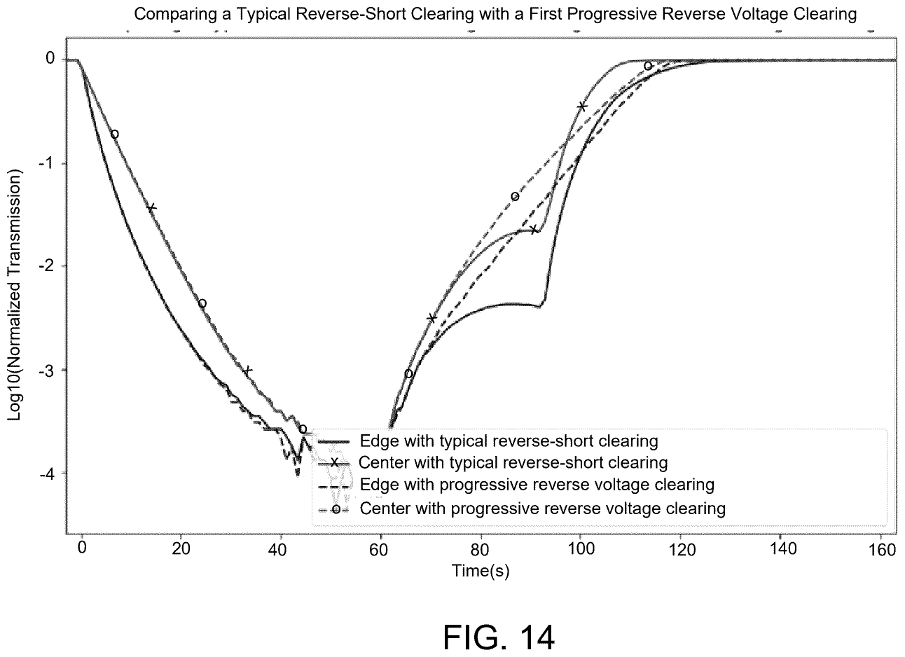

A third method 120 to improve clearing is illustrated in FIG. 13. In this third method 120, a reverse bias at decreasing voltages is first applied for a first predetermined time in incremental steps (step 122), followed by a short until clear (step 124). By reducing the reverse bias voltage, the process of generating counter species is slowed down before any excess counter species can be generated. This is because the lower the voltage the slower the rate at which species or counter species are generated. FIG. 14 shows a graph comparing the impact of this third method 120 on transmission at the perimeter and center regions. In the example used to create the graph, the negative bias is applied for 50 seconds total and starts at 1200 mV and is decreased by 100 mV voltage increments to 300 mV at equal time intervals. As compared to the prior method, the transmission curve shows a great improvement in the smoothness of the curve and effectively eliminates any visible halos.

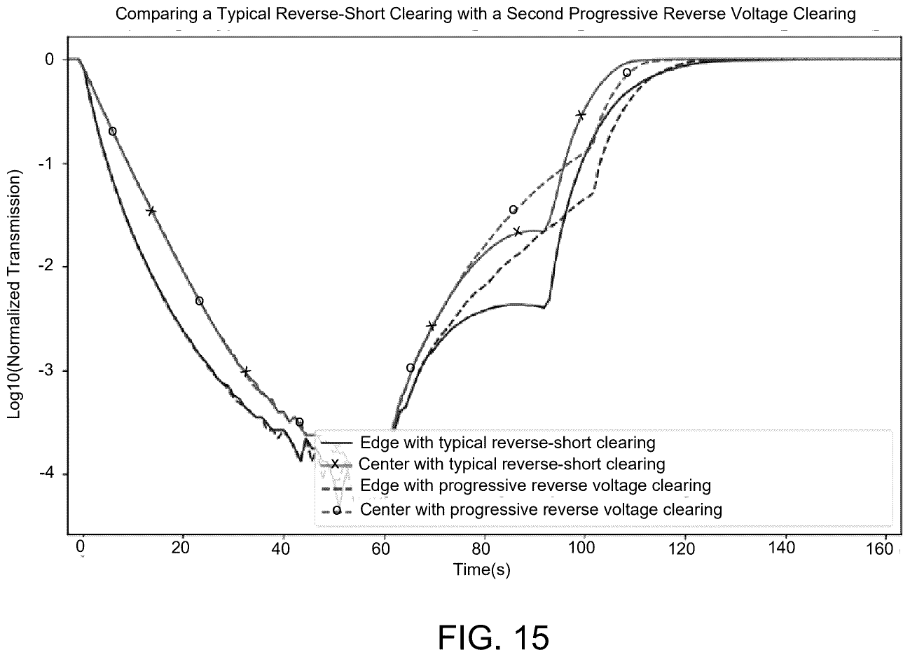

FIG. 15 shows a graph of a variation of the third method 120 whereby the reverse bias voltage is decreased at 100 mV increments in uniform intervals from 1200 mV to 700 mV for a total of 35 seconds before shorting. This variation slightly increases the clearing time but is not quite as smooth as the example illustrated in FIG. 14. Nonetheless, this example illustrates that the end voltage reduction, voltage decrements, and time intervals may be varied and optimized for the particular LAD. LADs of difference sizes and shapes and having different electrochromic media may require different end voltage reductions, voltage decrements, and time intervals. Furthermore, the first and second predetermined times in the above methods may be varied as the clearing times are impacted by a number of factors including the ambient temperature. Thus, one may select the parameters of the method as a function of a sensed temperature for a particular LAD having a known size, shape, cell spacing, and chemistry. When you apply decreasing voltage during progressive reverse bias, the voltage steps need not be constant and the time interval between steps need not be uniform as well. In most cases, the first predetermined time will be longer than the second predetermined time.

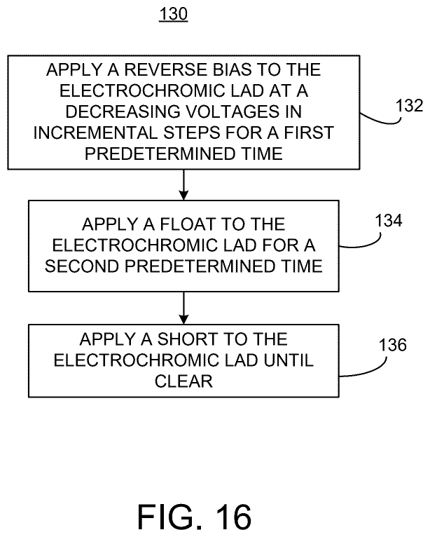

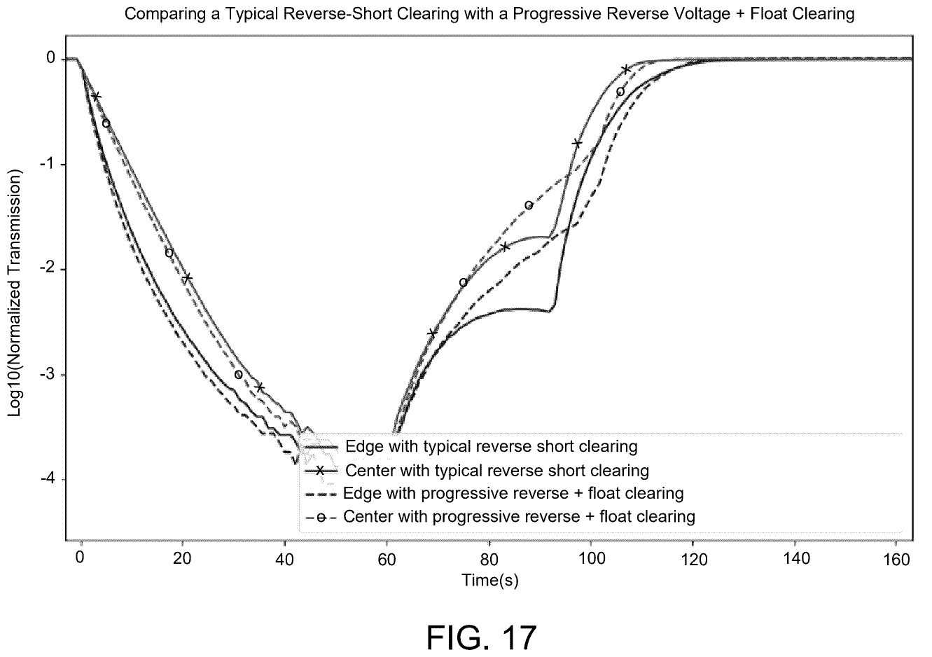

Although particular methods are discussed above using different steps, various combinations of these steps may be used. For example, a fourth method 130 is illustrated in FIG. 16 in which a reverse bias at decreasing voltages is first applied for a first predetermined time in incremental steps (step 132), followed by a float step (step 134) and then a short until clear (step 136). FIG. 17 shows a graph comparing the impact of this fourth method 130 on transmission at the perimeter and center regions. In the example used to create the graph, the negative bias is applied for 30 seconds total and is decreased by 100 mV steps at equal time intervals for a total reduction of 800 mV. Various other combinations of a reverse bias at constant or decreasing voltages, a float, a forward bias application, and a short may be used in various orders.

Whenever the term “constant voltage” is used, it should be appreciated that this may be a constant DC voltage or an average voltage over the time period of application such as when an AC or PWM voltage is applied.

According to the broadest aspect of the present disclosure, a method is provided for clearing an electrochromic device that has previously been darkened by application of a forward bias voltage, the method including the steps of applying a reverse bias to the electrochromic device for a first predetermined time and shorting the electrochromic device until cleared. The method further includes, after applying the reverse bias, (1) applying to the electrochromic device for a second predetermined time at least one of: a forward bias voltage and a float, and/or (2) applying the reverse bias at decreasing voltages.

In this document, relational terms, such as “first,” “second,” and the like, are used solely to distinguish one entity or action from another entity or action, without necessarily requiring or implying any actual such relationship or order between such entities or actions.

As used herein, the term “and/or” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

For purposes of this disclosure, the term “associated” generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within 10% of each other, such as within 5% of each other, or within 2% of each other.

The term “transparent” is applied in the relative sense. “Transparent” refers to an optical element or material that is substantially transmissive at wavelengths of interest and thus generally allows light at such wavelengths to pass therethrough. The wavelengths in question will vary based on the context. However, in the event the wavelengths in question are not readily apparent, the wavelengths in question shall generally refer to visible light.

According to a first aspect of the present disclosure, a method is provided for clearing an electrochromic device that has previously been darkened by application of a forward bias voltage, the method including the steps of: applying a reverse bias to the electrochromic device for a first predetermined time; applying to the electrochromic device for a second predetermined time at least one of: a forward bias voltage and a float; and shorting the electrochromic device until cleared.

In the first aspect, the reverse bias may be applied at a constant voltage.

In the first aspect, the reverse bias may be applied at decreasing voltages.

According to the above first aspect, the reverse bias may be applied at decreasing voltages in voltage increments.

According to the above first aspect, the reverse bias voltage may be decreased in voltage increments of 100 mV.

Also, according to the above first aspect, the reverse bias voltage may be decreased in voltage increments at equal time intervals.

According to the above first aspect, the first predetermined time is longer than the second predetermined time.

According to a second aspect of the present disclosure, a method is provided for clearing an electrochromic device that has previously been darkened by application of a forward bias voltage, the method including the steps of: applying a reverse bias at decreasing voltage to the electrochromic device for a first predetermined time; and shorting the electrochromic device until cleared.

The above second aspect may further include, after applying the reverse bias and before shorting, applying to the electrochromic device for a second predetermined time at least one of: a forward bias voltage and a float.

The above second aspect may further include, after applying the reverse bias and before shorting, applying to the electrochromic device for a second predetermined time a forward bias voltage.

The above second aspect may further include, after applying the reverse bias and before shorting, applying a float to the electrochromic device for a second predetermined time.

According to the above second aspect, the first predetermined time is longer than the second predetermined time.

According to the above second aspect, the reverse bias may be applied at decreasing voltages in voltage increments.

According to the above second aspect, the reverse bias voltage may be decreased in voltage increments of 100 mV.

Also, according to the above second aspect, the reverse bias voltage may be decreased in voltage increments at equal time intervals.

According to a third aspect of the present disclosure, a method is provided for clearing an electrochromic device that has previously been darkened by application of a forward bias voltage, the method including the steps of: applying a reverse bias to the electrochromic device for a first predetermined time; applying a forward bias to the electrochromic device for a second predetermined time; and shorting the electrochromic device until cleared.

In the third aspect, the reverse bias may be applied at a constant voltage.

In the third aspect, the reverse bias may be applied at decreasing voltages.

According to the above third aspect, the reverse bias may be applied at decreasing voltages in voltage increments.

According to the above third aspect, the reverse bias voltage may be decreased in voltage increments of 100 mV.

Also, according to the above third aspect, the reverse bias voltage may be decreased in voltage increments at equal time intervals.

According to the above third aspect, the first predetermined time is longer than the second predetermined time.

It should be appreciated by those skilled in the art that the above-described components may be combined in additional or alternative ways not explicitly described herein. Modifications of the various implementations of the disclosure will occur to those skilled in the art and to those who apply the teachings of the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

What is claimed is:

1. A method of clearing an electrochromic device that has previously been darkened by application of a forward bias voltage, the method comprising the steps of:
applying a reverse bias to the electrochromic device for a first predetermined time;
applying to the electrochromic device for a second predetermined time at least one of: a forward bias voltage and a float; and
shorting the electrochromic device until cleared.

2. The method of claim 1, wherein the reverse bias is applied at a constant voltage.

3. The method of claim 1, wherein the reverse bias is applied at decreasing voltages.

4. The method of claim 3, wherein the reverse bias is applied at decreasing voltages in voltage increments.

5. The method of claim 4, wherein the reverse bias voltage is decreased in voltage increments of 100 mV.

6. The method of claim 4, wherein the reverse bias voltage is decreased in voltage increments at equal time intervals.

7. The method of claim 1, wherein the first predetermined time is longer than the second predetermined time.

8. A method of clearing an electrochromic device that has previously been darkened by application of a forward bias voltage, the method comprising the steps of:
applying a reverse bias at decreasing voltage to the electrochromic device for a first predetermined time; and
shorting the electrochromic device until cleared.

9. The method of claim 8, wherein after applying the reverse bias and before shorting, applying to the electrochromic device for a second predetermined time at least one of: a forward bias voltage and a float.

10. The method of claim 8, wherein after applying the reverse bias and before shorting, applying to the electrochromic device for a second predetermined time a forward bias voltage.

11. The method of claim 8, wherein after applying the reverse bias and before shorting, applying a float to the electrochromic device for a second predetermined time.

12. The method of claim 9, wherein the first predetermined time is longer than the second predetermined time.

13. The method of claim 8, wherein the reverse bias is applied at decreasing voltages in voltage increments.

14. The method of claim 13, wherein the reverse bias voltage is decreased in voltage increments of 100 mV.

15. The method of claim 13, wherein the reverse bias voltage is decreased in voltage increments at equal time intervals.

16. A method of clearing an electrochromic device that has previously been darkened by application of a forward bias voltage, the method comprising the steps of:
applying a reverse bias to the electrochromic device for a first predetermined time;
applying a forward bias to the electrochromic device for a second predetermined time; and
shorting the electrochromic device until cleared.

17. The method of claim 16, wherein the reverse bias is applied at a constant voltage.

18. The method of claim 16, wherein the reverse bias is applied at decreasing voltages.

19. The method of claim 18, wherein the reverse bias is applied at decreasing voltages in voltage increments at equal time intervals.

20. The method of claim 16, wherein the first predetermined time is longer than the second predetermined time.
